(19) United States
(12) Patent Application Publication
(10) Pub. No.: US 2008/0022297 A1
(43) Pub. Date: Jan. 24, 2008

(54) System and method of sharing private content

(75) Inventors: Edward Walter, Boerne, TX (US); Larry B. Pearson, San Antonio, TX (US)

Correspondence Address: TOLER SCHAFFER, LLP, 8500 BLUFFSTONE COVE, SUITE A201, AUSTIN, TX, 78759, US

(73) Assignee: SBC Knowledge Ventures, LP, Reno, NV (US)

(21) Appl. No.: 11/476,927

(22) Filed: Jun. 28, 2006

(51) Int. Cl. H04N 7/173; H04N 7/16

(52) U.S. Cl. 725/25; 725/112; 725/113

(57) ABSTRACT

The present disclosure is directed to a system and method of sharing private content. In a particular embodiment, the method includes receiving a designation of a share location from which private content of a first user of an Internet Protocol Television (IPTV) system can be obtained. The method also includes receiving identifications of a plurality of other users of the IPTV system. The method also includes notifying a video server to include an indicator of the private content with video content sent to a plurality of set-top box devices, where each of the plurality of other users is associated with one of the plurality of set-top box devices.

### FIELD OF THE DISCLOSURE

The present disclosure relates generally to sharing private content.

### BACKGROUND

Television viewing is part of daily life for many people. The wealth of content available from television service providers allows many people to find entertaining and informative programming despite their varying interests. Individuals having a similar interest may wish to share information with each other during certain programs. However, they must typically interrupt each other during such programs or wait until such programs have ended before information can be shared. Hence, there is a need for a system and method of sharing private content.

### BRIEF DESCRIPTION OF THE DRAWINGS

FIG. 1 is a block diagram of a particular illustrative embodiment of a system to share private content;

FIG. 2 is a block diagram of a second particular illustrative embodiment of a system to share private content;

FIG. 3 is a flow diagram of a particular illustrative embodiment of a method of sharing private content;

FIG. 4 is a flow diagram of a second particular illustrative embodiment of a method of sharing private content;

FIG. 5 is a flow diagram of a third particular illustrative embodiment of a method of sharing private content;

FIG. 5 is a flow diagram of a third particular illustrative embodiment of a method of sharing private content;

FIG. 6 is a flow diagram of a fourth particular illustrative embodiment of a method of sharing private content;

FIG. 7 is a diagram of a particular illustrative embodiment of a graphical user interface to share private content;

FIG. 8 is a diagram of a second particular illustrative embodiment of a graphical user interface to share private content; and

FIG. 9 is a diagram of an illustrative embodiment of a general computer system.

### DETAILED DESCRIPTION OF THE DRAWINGS

The present disclosure is directed to a set-top box device that includes a processor and a memory device accessible to the processor. The set-top box device also includes a buffer to receive video content from a video server of an Internet Protocol Television (IPTV) system. The memory device includes instructions to receive an indicator of private content from the video server, where the private content is associated with a first user of the Internet Protocol Television (IPTV) system. Further, the memory device includes instructions to send the indicator with the video content to a display device coupled to the set-top box device. In addition, the memory device includes instructions to receive a selection of the indicator. The memory device also includes instructions to send a request to view the private content to the video server.

In another embodiment, the disclosure is directed to a method of sharing private content that includes receiving a designation of a share location from which private content of a first user of an Internet Protocol Television (IPTV) system can be obtained. The method also includes receiving identifications of a plurality of other users of the IPTV system. The method also includes notifying a video server to include an indicator of the private content with video content sent to a plurality of set-top box devices, where each of the plurality of other users is associated with one of the plurality of set-top box devices.

In another embodiment, the disclosure is directed to a method of sharing private content that includes receiving a notification at a video server to include an indicator of private content of a first user of an Internet Protocol Television (IPTV) system with video content sent to a plurality of set-top box devices, where each of the plurality of set-top box devices is associated with one of a plurality of other users of the IPTV system. The method also includes receiving a request to view the private content from one of the plurality of set-top box devices. The method also includes sending a communication to a publication server of the IPTV system indicating that the request has been received. The method also includes receiving the private content and sending the private content to the one of the plurality of set-top box devices.

In another embodiment, the disclosure is directed to a method of sharing private content that includes receiving an indicator of private content with video content from a video server at a set-top box device, where the private content is associated with a first user of an Internet Protocol Television (IPTV) system and the set-top box device is associated with one of a plurality of other users identified by the first user. The method also includes receiving a selection of the indicator at the set-top box device. The method also includes sending a request to view the private content to the video server and receiving the private content at the set-top box device.

In another embodiment, the disclosure is directed to a computer program embedded in a computer-readable medium. The computer program includes instructions to receive a designation of a share location from which private content of a first user of an Internet Protocol Television (IPTV) system can be obtained. The computer program also includes instructions to receive identifications of a plurality of other users of the IPTV system. The computer program also includes instructions to notify a video server to include an indicator of the private content with video content sent to a plurality of set-top box devices, where each of the plurality of other users is associated with one of the plurality of set-top box devices.

In another embodiment, the disclosure is directed to a computer program embedded in a computer-readable medium. The computer program includes instructions to receive video content and data related to an indicator of private content from a video server, where the private content is associated with a first user of the Internet Protocol Television (IPTV) system. The computer program also includes instructions to generate the indicator based on the data and to send the indicator with the video content to a display device. The computer program also includes instructions to receive a selection of the indicator and instructions to send a request to view the private content to the video server.

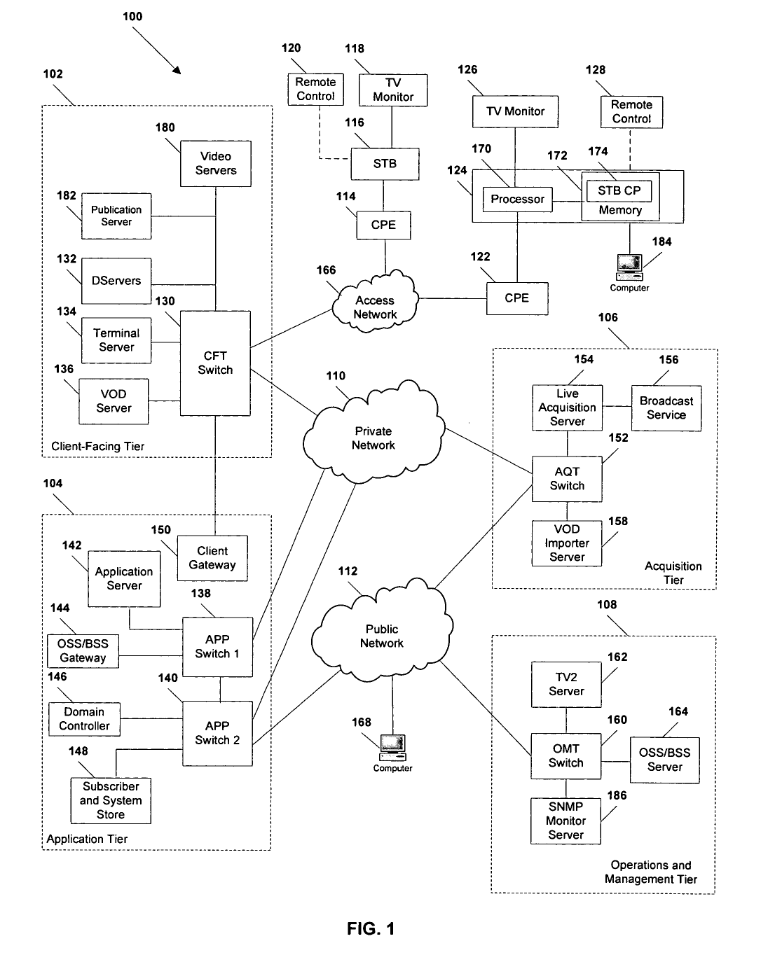

Referring to FIG. 1, an illustrative embodiment of an Internet Protocol Television (IPTV) system that may be used to share private content is illustrated and is generally designated 100. As shown, the system 100 can include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 can be coupled to the private network 110. Further, the application tier 104 can be coupled to the private network 110 and to the public network 112. The acquisition tier 106 can also be coupled to the private network 110 and to the public network 112. Additionally, the operations and management tier 108 can be coupled to the public network 112.

As illustrated in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104, including, but not limited to, a client gateway 150, can communicate directly with the client-facing tier 102.

The client-facing tier 102 can communicate with user equipment via an access network 166, such as an Internet Protocol Television (IPTV) access network. In an illustrative embodiment, customer premises equipment (CPE) 114, 122 can be coupled to a local switch, router, or other device of the access network 166. The client-facing tier 102 can communicate with a first representative set-top box device 116 at a first customer premise via the first CPE 114 and with a second representative set-top box device 124 at a second customer premise via the second CPE 122. The CPE 114, 122 can include routers, local area network devices, modems, such as digital subscriber line (DSL) modems, any other suitable devices for facilitating communication between a set-top box device and the access network 166, or any combination thereof.

In a particular embodiment, the client-facing tier 102 can be coupled to the CPE 114, 122 via fiber optic cables. Alternatively, the CPE 114, 122 can be digital subscriber line (DSL) modems that are coupled to one or more network nodes via twisted pairs, and the client-facing tier 102 can be coupled to the network nodes via fiber-optic cables. Each set-top box device 116, 124 can process data received via the access network 166, via an IPTV software platform, such as Microsoft® TV IPTV Edition.

The first set-top box device 116 can be coupled to a first external display device, such as a first television monitor 118, and the second set-top box device 124 can be coupled to a second external display device, such as a second television monitor 126. Moreover, the first set-top box device 116 can communicate with a first remote control 120, and the second set-top box device 124 can communicate with a second remote control 128. The set-top box devices 116, 124 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 116, 124 can receive data, video, or any combination thereof, from the client-facing tier 102 via the access network 166 and render or display the data, video, or any combination thereof, at the display device 118, 126 to which it is coupled. In an illustrative embodiment, the set-top box devices 116, 124 can include tuners that receive and decode television programming signals or packet streams for transmission to the display devices 118, 126. Further, the set-top box devices 116, 124 can include a STB processor 170 and a STB memory device 172 that is accessible to the STB processor 170. In one embodiment, a computer program, such as the STB computer program 174, can be embedded within the STB memory device 172. In another illustrative embodiment, a user computing device 184, such as a personal computer, laptop or local server, can be coupled to a set-top box device, such as the second representative set-top box device 124, for example, via a universal serial bus (USB) connection or other connection.

In an illustrative embodiment, the client-facing tier 102 can include a client-facing tier (CFT) switch 130 that manages communication between the client-facing tier 102 and the access network 166 and between the client-facing tier 102 and the private network 110. As illustrated, the CFT switch 130 is coupled to one or more data servers, such as D-servers 132, that store, format, encode, replicate, or otherwise manipulate or prepare video content for communication from the client-facing tier 102 to the set-top box devices 116, 124. The CFT switch 130 can also be coupled to a terminal server 134 that provides terminal devices with a connection point to the private network 110. In a particular embodiment, the CFT switch 130 can be coupled to a video-on-demand (VOD) server 136 that stores or provides VOD content imported by the IPTV system 100.

Further, the CFT switch 130 is coupled to one or more video servers 180 that receive video content and transmit the content to the set-top boxes 116, 124 via the access network 166. In a particular embodiment, the CFT switch 130 can be coupled to one or more publication servers 182 that facilitate the formation of groups that share private content and the inclusion of indicators of such private content with video content received by users in a group.

In an illustrative embodiment, the client-facing tier 102 can communicate with a large number of set-top boxes, such as the representative set-top boxes 116, 124 over a wide geographic area, such as a regional area, a metropolitan area, a viewing area, a designated market area or any other suitable geographic area, market area, or subscriber or customer group that can be supported by networking the client-facing tier 102 to numerous set-top box devices. In a particular embodiment, the CFT switch 130, or any portion thereof, can include a multicast router or switch that feeds one or more video streams from a video server to multiple set-top box devices.

As illustrated in FIG. 1, the application tier 104 can communicate with both the private network 110 and the public network 112. The application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. In a particular embodiment, the application server 142 can provide applications to the set-top box devices 116, 124 via the access network 166, which enable the set-top box devices 116, 124 to provide functions, such as display, messaging, processing of IPTV data and VOD material, etc. In a particular embodiment, the OSS/BSS gateway 144 includes operation systems and support (OSS) data, as well as billing systems and support (BSS) data. In one embodiment, the OSS/BSS gateway 144 can provide or restrict access to an OSS/BSS server 164 that stores operations and billing systems data.

The second APP switch 140 can be coupled to a domain controller 146 that provides Internet access, for example, to users at their computers 168 via the public network 112. For example, the domain controller 146 can provide remote Internet access to IPTV account information, e-mail, personalized Internet services, or other online services via the public network 112. In addition, the second APP switch 140 can be coupled to a subscriber and system store 148 that includes account information, such as account information that is associated with users who access the IPTV system 100 via the private network 110 or the public network 112. In an illustrative embodiment, the subscriber and system store 148 can store subscriber or customer data and create subscriber or customer profiles that are associated with IP addresses of corresponding set-top box devices 116, 124.

In a particular embodiment, the application tier 104 can include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto. In an illustrative embodiment, the set-top box devices 116, 124 can access the IPTV system 100 via the access network 166, using information received from the client gateway 150. User devices can access the client gateway 150 via the access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the access network 166.

For example, when the first representative set-top box device 116 accesses the client-facing tier 102 via the access network 166, the client gateway 150 can verify subscriber information by communicating with the subscriber and system store 148 via the private network 110. Further, the client gateway 150 can verify billing information and status by communicating with the OSS/BSS gateway 144 via the private network 110. In one embodiment, the OSS/BSS gateway 144 can transmit a query via the public network 112 to the OSS/BSS server 164. After the client gateway 150 confirms subscriber and/or billing information, the client gateway 150 can allow the set-top box device 116 to access IPTV content and VOD content at the client-facing tier 102. If the client gateway 150 cannot verify subscriber information for the set-top box device 116, e.g., because it is connected to an unauthorized twisted pair, the client gateway 150 can block transmissions to and from the set-top box device 116 beyond the access network 166.

As indicated in FIG. 1, the acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives or acquires television content, movie content, advertisement content, other video content, or any combination thereof, from a broadcast service 156, such as a satellite acquisition system or satellite head-end office. In a particular embodiment, the live acquisition server 154 can transmit content to the AQT switch 152, and the AQT switch 152 can transmit the content to the CFT switch 130 via the private network 110.

In an illustrative embodiment, content can be transmitted to the D-servers 132, where it can be encoded, formatted, stored, replicated, or otherwise manipulated and prepared for communication from the video server(s) 180 to the set-top box devices 116, 124. The CFT switch 130 can receive content from the video server(s) 180 and communicate the content to the CPE 114, 122 via the access network 166. The set-top box devices 116, 124 can receive the content via the CPE 114, 122, and can transmit the content to the television monitors 118, 126. In an illustrative embodiment, video or audio portions of the content can be streamed to the set-top box devices 116, 124.

Further, the AQT switch 152 can be coupled to a video-on-demand importer server 158 that receives and stores television or movie content received at the acquisition tier 106 and communicates the stored content to the VOD server 136 at the client-facing tier 102 via the private network 110. Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When users issue requests for VOD content via the set-top box devices 116, 124, the requests can be transmitted over the access network 166 to the VOD server 136, via the CFT switch 130. Upon receiving such requests, the VOD server 136 can retrieve the requested VOD content and transmit the content to the set-top box devices 116,124 across the access network 166, via the CFT switch 130. The set-top box devices 116, 124 can transmit the VOD content to the television monitors 118, 126. In an illustrative embodiment, video or audio portions of VOD content can be streamed to the set-top box devices 116, 124.

FIG. 1 further illustrates that the operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to an OSS/BSS server 164 and to a simple network management protocol (SNMP) monitor 186 that monitors network devices within or coupled to the IPTV system 100. In a particular embodiment, the OMT switch 160 can communicate with the AQT switch 152 via the public network 112.

In an illustrative embodiment, the live acquisition server 154 can transmit content to the AQT switch 152, and the AQT switch 152, in turn, can transmit the content to the OMT switch 160 via the public network 112. In this embodiment, the OMT switch 160 can transmit the content to the TV2 server 162 for display to users accessing the user interface at the TV2 server 162. For example, a user can access the TV2 server 162 using a personal computer (PC) 168 coupled to the public network 112.

In a particular illustrative embodiment, a user, such as a user of the second representative set-top box device 124, can develop private content. For example, User A can develop video, one or more documents, or any combination thereof, related to a particular subject, such as the Roman Empire, at the computing device 184. In addition, User A can designate, select, or create a publication list, such as a “Buddy List,” that includes other users of the IPTV system 100 with whom User A desires to share the private content. In another embodiment, User A can share the private content with users of other systems that can access the IPTV system 100 or a device thereof, via an access portal.

In an illustrative embodiment, User A can search to find television programs and other video content transmitted by the video server(s) 180 that relate to a subject matter of the private content, such as documentary programs, fictional programs, or any combination thereof, related to ancient Rome. Further, User A can develop tags, such as icons or other indicators, that will be displayed during the video content found by the search via set-top box devices associated with users included in the publication list. For example, a User B associated with the first representative set-top box device 116 could be included in the publication list of User A.

In a particular embodiment, User A can communicate with the publication server(s) 182 to indicate the video content with which User A desires to include tags associated with the private content. User A can also indicate the desired publication list for the private content. In addition, User A can also communicate to the publication server(s) 182 a share location from which the private content may be pulled, downloaded, or otherwise obtained. For example, User A can indicate that the private content can be obtained from an IP address of the computing device 184, such as a personal computer, laptop or local server. In another embodiment, User A can indicate that the private content can be obtained from an IP address of the second representative set-top box device 124, which can store the private content or retrieve the private content from the computing device 184.

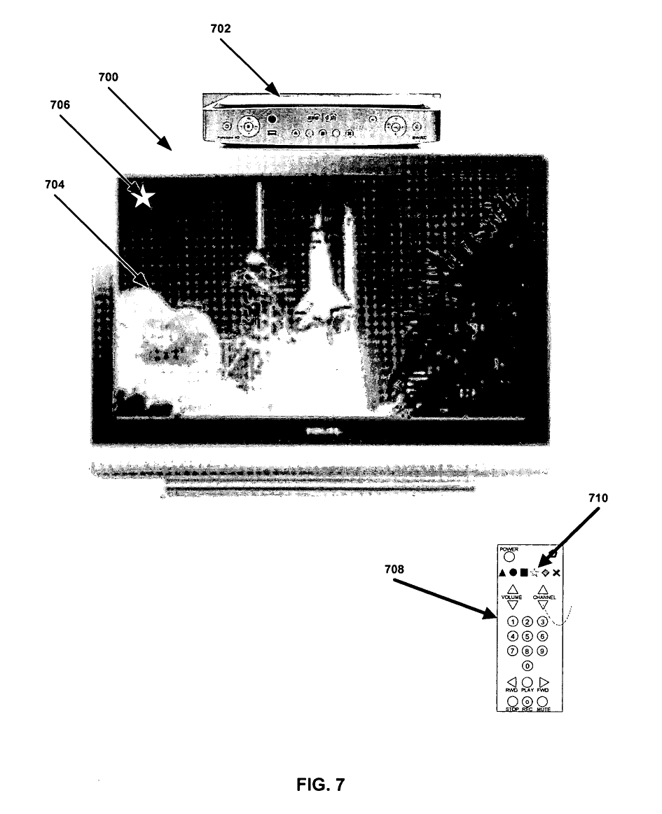

In an illustrative embodiment, the publication server(s) 182 can instruct or otherwise notify the video server(s) 180 that transmit video content designated by User A to include the tags developed by User A when such video content is transmitted to set-top box devices associated with users on User A's publication list, such as the first representative set-top box device 116. The video server(s) 180 can include the tags with the video content, and the tags can cause icons or other indicators to be displayed at display devices coupled to set-top box devices associated with users on User A's publication list. For example, an indicator of User A's private content can be displayed to User B at the television monitor 118, during programs related to the Roman Empire. An example of such an indicator is illustrated in FIG. 7.

In an illustrative embodiment, a user can select an indicator of private content displayed at a display device in order to view the private content developed by User A. The set-top box device of the user selecting the indicator can send a request to the video server(s) 180, publication server(s) 182, or any combination thereof, to receive the private content of User A. In a particular embodiment, the publication server(s) 182 can retrieve the private content from the share location indicated by User A and send the private content to the video server(s) 180 for transmission to the set-top box device of the requesting user. In another illustrative embodiment, the publication server(s) 182 can send the share location to the set-top box device of the requesting user, and the set-top box device can retrieve the private content from the share location.

For example, User B can use the remote control 120 to select an indicator displayed at the television monitor 118. The first representative set-top box device 116 can issue a request for the private content associated with the indicator to the video server(s) 180 from which video content is being received by the first representative set-top box device 116. The video server(s) 180 can instruct or otherwise notify the publication server(s) 182 to obtain the private content. The publication server(s) 182 can retrieve the private content from User A's computing device 184 directly or via the second representative set-top box device 124 and forward the private content to the video server(s) 180 for transmission to the first representative set-top box device 116. User B can review the private content at the television monitor 118. In an illustrative embodiment, a recording module at the first representative set-top box device 116 can record video content while User B reviews the private content, such that User B need not miss the video content while reviewing the private content.

In a particular embodiment, the publication server(s) 182 or other server(s) of the IPTV system 100 can restrict the inclusion of indicators with video content. For example, when User A indicates that User B is to be included in the publication list for the private content, the publication server(s) 182 can determine whether User B will accept private content indicators from User A. In an exemplary embodiment, the publication server(s) 182 can determine whether User A is included in a Buddy List of User B or a list of allowed or prohibited users associated with User B at the publication server(s) 182. If User A is on the Buddy List of User B, for example, indicators of private content of User A can be included with video content received by User B. On the other hand, if User A is included in a list of prohibited users associated with User B, indicators of private content of User A can not be included with video content received by User B, even when User A adds User B to User A's publication list.

Additionally, the publication server(s) 182 or other server(s) of the IPTV system 100 can control the retrieval of private content. In an illustrative embodiment, when User B reviews User A's private content, User B can designate a publication list that includes users to whom User B desires to send indicators of the private content, with or without additional private content developed by User B. For example, User B can determine that a User C, who is not included in User A's publication list, would be interested in User A's private content. User B can notify the publication server(s) 182 to include indicators of User A's private content with video content related to the Roman Empire that is transmitted to a set-top box device associated with User C. The publication server(s) 182 can instruct or otherwise notify the video server(s) 180 to include such indicators with video content related to the Roman Empire that is transmitted to a set-top box device associated with User C.

In an illustrative embodiment, when User A notifies the publication server(s) 182 of the publication list and the video content with which User A wants indicators to be included for users on the publication list, User A can also notify the publication server(s) 182 of one or more privacy rules that govern who can review the private content. For example, User A can indicate that no users other than those on User A's publication list can review the private content. In another embodiment, User A can indicate that one or more particular users other than those on the publication list can or cannot review the private content. When a request to review the private content is received at the publication server(s) 182, the publication server(s) 182 can determine whether the requesting user is on User A's publication list or whether the requesting user satisfies any of User A's privacy rules, before retrieving the private content to be transmitted to the requesting user.

In another illustrative embodiment, a set-top box device, the video server(s) 180, or any combination thereof, can control the inclusion of indicators of private content with video content displayed at a display device. For example, a User D living in User B's household can log in to the first representative set-top box device 116. If User D is not included with User A's publication list, the first representative set-top box device 116 can prevent indicators of User A's private content from being displayed at the television monitor 118. In another embodiment, the video server(s) 180 can determine that User D is using the first representative set-top box device 116 and can not include such indicators with video content transmitted to the first representative set-top box device 116. In another illustrative embodiment, User B can select an option via the set-top box device 116 to display no such indicators during a designated time, program, or any combination thereof. In response to such a selection, the first representative set-top box device 116 can prevent any indicators received from the video server(s) 180 from being included with video content displayed at the television monitor 118.

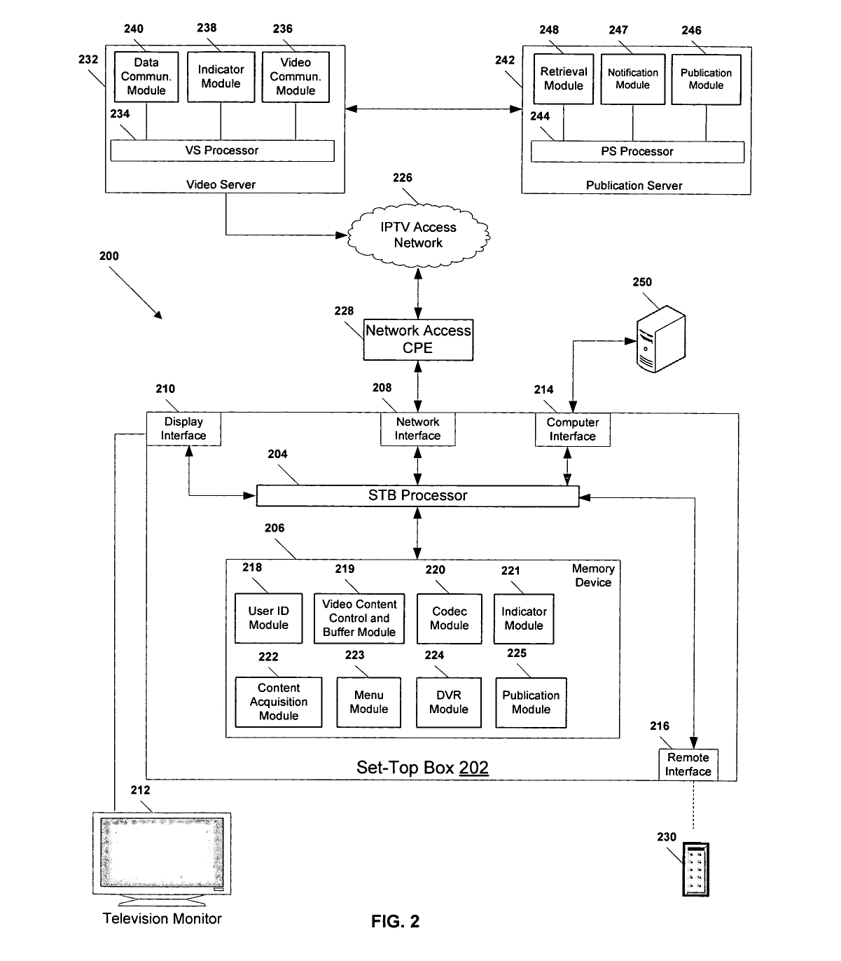

Referring to FIG. 2, a second particular embodiment of a system to share private content is illustrated and designated generally at 200. The system 200 includes a set-top box device 202 that communicates with a video server 232 of an Internet Protocol Television (IPTV) system via an IPTV access network 226. Further, the video server 232 is coupled to a publication server 242. In addition, the set-top box device 202 can communicate with a local server 250 or other user computing device via a computer interface 214, such as a universal serial bus (USB) interface or other interface. In an illustrative, non-limiting embodiment, local server 250 can communicate directly with the IPTV access network 226.

As indicated in FIG. 2, the set-top box device 202 includes a STB processor 204 and a memory device 206 accessible to the STB processor 204. In an illustrative, non-limiting embodiment, the STB processor 204 can communicate with the IPTV access network 226, via the network interface 208. In a particular embodiment, network access customer premises equipment (CPE) 228 can facilitate communication between the network interface 208 and the IPTV access network 226. The network access CPE 228 can include a router, a local area network device, a modem, such as a digital subscriber line (DSL) modem, any other suitable device for facilitating communication between the network interface 208 of the set-top box device 202 and the IPTV access network 226, or any combination thereof. Further, the STB processor 204 can communicate video content to a display device 212 via a display interface 210. In addition, the STB processor 204 can receive commands from a remote control device 230 via a remote interface 216.

In a particular embodiment, the memory device 206 can include a user identification module 218 that is executable by the STB processor 204 to receive login information or similar information identifying a particular user using the set-top box device 202. The memory device 206 can also include a video content control and buffer module 219 that is executable by the STB processor 204 to receive video content requested by a user and to buffer the video content before transmitting it to the display interface 210, in order to prevent underflow. Further, the memory device 206 can include a codec module 220 that is executable by the STB processor 204 to decode video streams received from the IPTV system via the IPTV access network 226 prior to transmitting the video streams to the display device 212.

In a particular embodiment, the memory device 206 can include an indicator module 221 executable by the processor 204 to transmit icons or other indicators of private content received with video content to the display device 212. In another particular embodiment, the indicator module 221 can be executable by the processor 204 to prevent such indicators from being displayed when a command to block or prohibit indicators is received at the set-top box device 202; when a user logged in at the set-top box device 202 is not included in a publication list associated with private content; when a profile of a user logged in at the set-top box device 202 includes a preference to block or prohibit indicators; or any combination thereof. Further, the indicator module 221 can be executable by the processor 204 to receive a selection of an icon associated with private content.

In a particular embodiment, the memory device 206 can include a content acquisition module 222 executable by the processor 204 to receive a selection of an icon or other indicator displayed at the display device 212 and to retrieve private content associated with the indicator. For example, the content acquisition module 222 can be executable by the processor 204 to issue a command, instruction, or other communication to the video server 232 indicating that the private content has been requested. Further, the content acquisition module 222 can be executable by the processor 204 to receive the private content from the video server 232 and to send the private content to the display device 212.

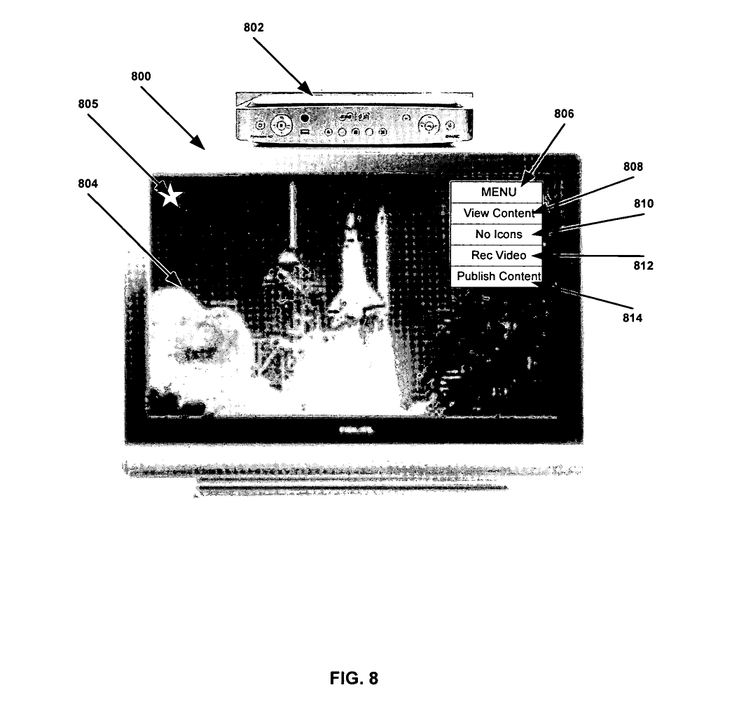

In a particular embodiment, the memory device 206 can include a menu module 223 executable by the processor 204 to send a menu related to sharing private content to the display device 212. For example, the menu module 223 can be executable by the processor 204 to generate a menu that includes selectable commands, such as a command to display private content, commands to display or not display icons or other indicators of private content, a command to return to programming from viewing private content, other commands, or any combination thereof. Further, the menu module 223 can be executable by the processor 204 to receive selections of commands and to issue instructions or other communications to other devices or modules of the system 200 to execute or otherwise implement selected commands. An example of a menu to share private content is illustrated in FIG. 8.

In a particular embodiment, the memory device 206 can include a digital video recorder (DVR) module 224 that is executable by the processor 204 to record and store video content received at the set-top box device 202. In an illustrative embodiment, the menu module 223 can be executable by the processor 204 to generate a menu that includes an option to record television programming while viewing private content. The DVR module 224 can record such television programming in response to a selection of the command from the menu.

In a particular embodiment, the memory device 206 can include a publication module 225 that is executable by the processor 204 to facilitate communication between a computing device 250 and the publication server 242 via the set-top box device 202. In an illustrative embodiment, the computing device 250 can be coupled to the set-top box device 202 via a computer interface 214. In an illustrative embodiment, a user who stores private content at the computing device 250 can communicate with the publication server 242 to indicate that the user desires to publish the private content to a list of other users, to designate tags associated with the private content, and to identify the computing device 250 as a share location from which the private content can be retrieved.

In a particular embodiment, the video server 232 can include a video server (VS) processor 234. The video server 232 can also include a video communication module 236 executable by the VS processor 234 to receive video content from a D-server or acquisition device of an IPTV system and to communicate the video content to one or more set-top box devices, such as the set-op box device 202. Further, the video server 232 can include an indicator module 238 executable by the VS processor 234 to include icons, tags, or other indicators of private content with the video content communicated to the set-top box device 202. In an illustrative embodiment, the indicator module 238 is executable by the VS processor 234 to include such indicators in response to a notification from the publication server 242 to include indicators with video content sent by the video server 232 to the set-top box device 202.

In a particular embodiment, the video server 232 can include a data communication module 240 executable by the VS processor 234 to receive a communication from the set-top box device 202 indicating that an icon, tag, or other indicator associated with private content has been selected. Further, the data communication module 240 can be executable by the VS processor 234 to retrieve or request the private content associated with a selected indicator from the publication server 242 or from a share location via the publication server 242. In an illustrative, non-limiting embodiment, the data communication module 240 can be executable by the VS processor 234 to facilitate communication between the publication server 242 and a computing device 250 coupled to the set-top box device 202. In an illustrative embodiment, the various modules 236-240 of the video server 232 can be included in a memory portion of the video server 232.

In a particular embodiment, the publication server 242 can include a PS processor 244. In addition, the publication server 242 can include a publication module 246 executable by the PS processor 244 to receive communications from a computing device, such as the computing device 250, indicating that a user desires to publish private content to other users. Further, the publication module 246 can be executable by the PS processor 244 to receive identifications of users to whom the private content is to be made available. In an illustrative embodiment, the publication module 246 can be executable by the PS processor 244 to receive privacy rules related to sharing of the private content. In addition, the publication module 246 can be executable by the PS processor 244 to receive designations of tags, icons, or other indicators associated with the private content, which are to be displayed with video content via the set-top boxes of users identified by the publication list. In an illustrative embodiment, the publication module 246 can be executable by the PS processor 244 to receive designations of movies, television programs, or any combination thereof, during which the tags, icons, or other indicators are to be displayed to users identified by the publication list. The publication module 246 can be executable by the PS processor 244 to receive a share location from which the private content can be retrieved.

In a particular embodiment, the publication server 242 can include a notification module 247 executable by the PS processor 244 to notify the video server 232 that one or more indicators of private content are to be included with video content sent to set-top boxes of users identified by the publication list. Further, the publication server 242 can include a retrieval module 248 executable by the PS processor 244 to receive a communication from the video server 232, for example, indicating that an indicator of private content has been selected at the set-top box device 202. The retrieval module 248 can be executable by the PS processor 244 to determine a share location where the private content is stored and to retrieve the private content from the share location. In addition, the retrieval module 248 can be executable by the PS processor 244 to send the private content to the video server 232, to direct the share location to send the private content to the video server 232, to direct the video server 232 to retrieve the private content from the share location, or any combination thereof.

In a particular illustrative embodiment, a user of the set-top box device 202 can develop private content. For example, the user (e.g., user A) can store video, images, data, one or more documents, or any combination thereof, related to a particular subject, such as the Roman Empire at the computing device 250. In addition, the user can designate, select, or create a publication list, such as a “Buddy List,” that includes other users with whom User A desires to share the private content. Further, User A can search to find television programs and other video content transmitted by the video server 232, for example, that relates to a subject matter of the private content, such as documentary programs, fictional programs, or any combination thereof, related to ancient Rome. The user can develop tags, icons or other indicators that are to be displayed during the video content found by the search via set-top box devices associated with users identified by the publication list.

In a particular embodiment, the user can communicate with the publication server 242 to indicate video content with which the user desires to include tags associated with the private content. Further, the user can indicate other users who are to have access to the private content. In addition, the user can specify a share location from which the private content may be pulled, downloaded, or otherwise obtained. For example, the user can indicate that the private content can be obtained from an IP address of the computing device 250, such as a personal computer or local server. In another embodiment, the user can indicate that the private content can be obtained from an IP address of the set-top box device 202, which can store the private content, retrieve the private content from the computing device 250, or any combination thereof.

In a particular embodiment, the publication server 242 can instruct or otherwise notify the video server 232 to include the tags designated by the user when certain video content is sent to set-top box devices associated with users identified by the publication list. In an illustrative, non-limiting embodiment, the video server 232 can include tags with the video content, and the tags can cause icons or other indicators to be displayed at display devices coupled to set-top box devices associated with users identified by the publication list. For instance, the publication server 242 can instruct or notify the video server 232 to include tags related to private content about the Roman Empire with video content related to ancient Rome that is received by users on a publication list associated with the private content.

In an illustrative embodiment, a user can issue a command to view the private content. In one embodiment, the user can issue such a command by selecting a tag, icon, or other indicator of the private content that is displayed with video content. In another embodiment, the user can select a command to view the private content from a menu of selectable commands that is displayed after the indicator is selected. The set-top box device of the user selecting the indicator can send a request to the video server 232, publication server 242, or any combination thereof, to receive the private content. In a particular embodiment, the publication server 242 can retrieve the private content from the computing device 250, the set-top box device 202, or any combination thereof, and can send the private content to the video server 232 for transmission to the set-top box device of the requesting user.

In a particular embodiment, a user associated with the set-top box device 202 can be identified to receive private content of another user. When the set-top box device 202 receives video content from the video server 232 that matches video content associated with the private content of the other user, one or more indicators can be displayed at the display device 212. The user of the set-top box device 202 can use the remote control 230, for example, to select an indicator, and the set-top box device 202 can issue a request for the private content to the video server 232. The video server 232 can instruct or otherwise notify the publication server 242 to obtain the private content. The publication server 242 can retrieve the private content from a share location associated with the private content and can send or cause another device to send the private content to the set-top box device 202. The set-top box device 202 can cause the private content to be displayed at the display device 212. In an illustrative, non-limiting embodiment, the user of the set-top box device 202 can select a command to record video content, such as by the DVR module 224, while viewing the private content.

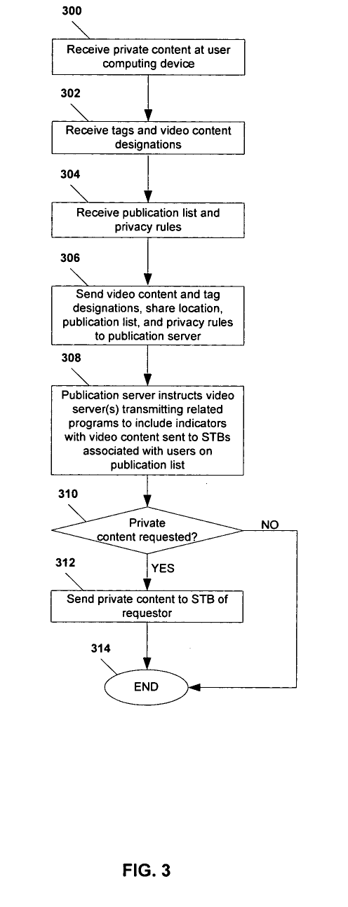

Referring to FIG. 3, a particular illustrative embodiment of a method of sharing private content is illustrated. At block 300, private content is received at a computing device, such as a personal computer or local server. Moving to block 302, designations of tags and particular video content are received at the computing device. For example, video content related to the subject matter of the private content can be received. Further, designations of icons or other indicators that are to be displayed with the designated video content can be received.

Proceeding to block 304, in an illustrative embodiment, a publication list is received that identifies users to whom the tags are to be sent with the designated video content. In one embodiment, the users can be subscribers or customers of an Internet Protocol Television (IPTV) system. Further, in a particular embodiment, privacy rules can be received that specify whether and to whom users on the publication list can extend access to the private content.

Continuing to block 306, the computing device communicates the designations of the video content and tags associated with the private content to a publication server. Further, the computing device communicates the publication list and the share location of the private content to the publication server. For example, the computing device can communicate an IP address from which the private content can be retrieved. In an illustrative embodiment, the computing device can communicate privacy rules to the publication server. In a particular embodiment, the computing device can communicate with the publication server via the Internet, for example. In another particular embodiment, the computing device can be coupled to a set-top box device that communicates with the publication server via an access network of an IPTV system.

In a particular embodiment, the method advances to block 308, and the publication server instructs one or more video content servers to include the received tags with designated video content that is sent to set-top boxes associated with users identified on the publication list. Such users can select one or more indicators associated with the tags to view the private content received at the computing device. In an illustrative embodiment, the method moves to decision step 310, and the computing device determines whether it has received a request for the private content. For example, where the computing device is designated as a share location of the private content, the request can be received at the computing device from a set-top box of a user identified on the publication list, via a publication server, a video server, or any combination thereof. In another example, the request can be received via a set-top box device coupled to the computing device.

If the computing device determines that it has not received a request, the method terminates at 314. On the other hand, if the computing device determines that it has received a request, the method proceeds to block 312, and the computing device sends the private content to the set-top box device of the requesting user. In a particular embodiment, the computing device can send the private content to the set-top box device of the requesting user via the publication server, a set-top box device coupled to the computing device, or any combination thereof. The method terminates at 314.

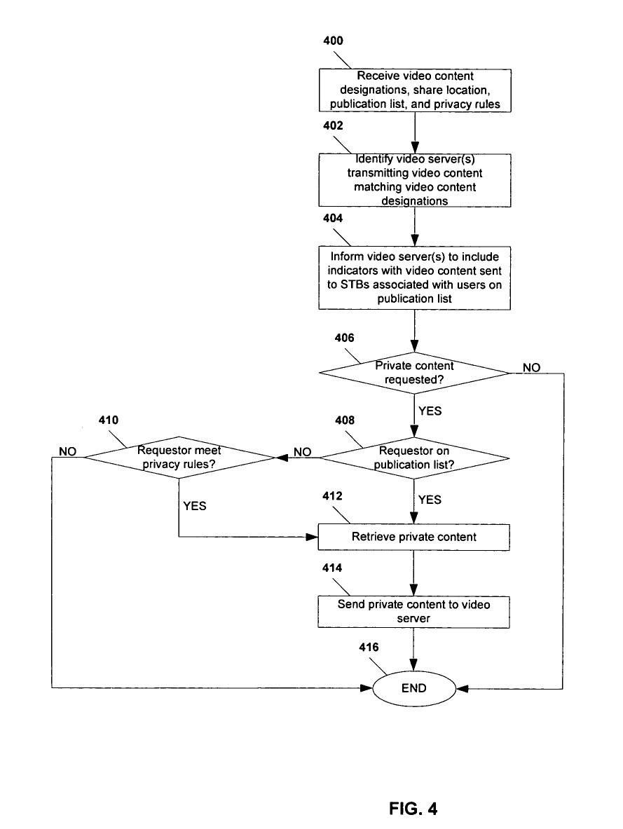

Referring to FIG. 4, a second particular illustrative embodiment of a method of sharing private content is illustrated. At block 400, designations of particular video content are received at a publication server. For example, designations of video content related to the subject matter of private content can be received. Further, the publication server can receive a share location from which the private content can be retrieved, such as an IP address of a local server or other computing device. In addition, the publication server can receive a publication list that identifies other parties to whom access to the private content is to be granted. Moreover, privacy rules can be received that specify who may access the private content without being identified by the publication list.

Moving to block 402, the publication server identifies one or more video servers that transmit video content matching one or more of the received video content designations. Proceeding to block 404, the publication server informs the video content server(s) to include indicators with video content sent to set-top boxes associated with parties identified by the publication list. In a particular embodiment, such users can select one or more of the indicators to view associated private content. The method continues to decision step 406, and the publication server determines whether it has received a request to view the private content.

If the publication server determines that it has not received a request, the method terminates at 416. On the other hand, if the publication server determines that it has received a request, the method proceeds to decision step 408, and the publication server determines whether the requesting party is identified by the publication list. If the requesting party is not identified by the publication list, the method moves to decision step 410, and the publication server determines whether the requesting party satisfies the received privacy rules. If the requesting party satisfies the privacy rules, the method moves to block 412 and continues. Conversely, if the requesting party does not satisfy the privacy rules, the method terminates at 416.

Returning to decision step 408, if the requesting party is identified by the publication list, the method proceeds to block 412, and the publication server retrieves the private content from the share location received at block 400. The method continues to block 414, and the publication server sends the private content to the requesting party, via a video server, for example. The method terminates at 416.

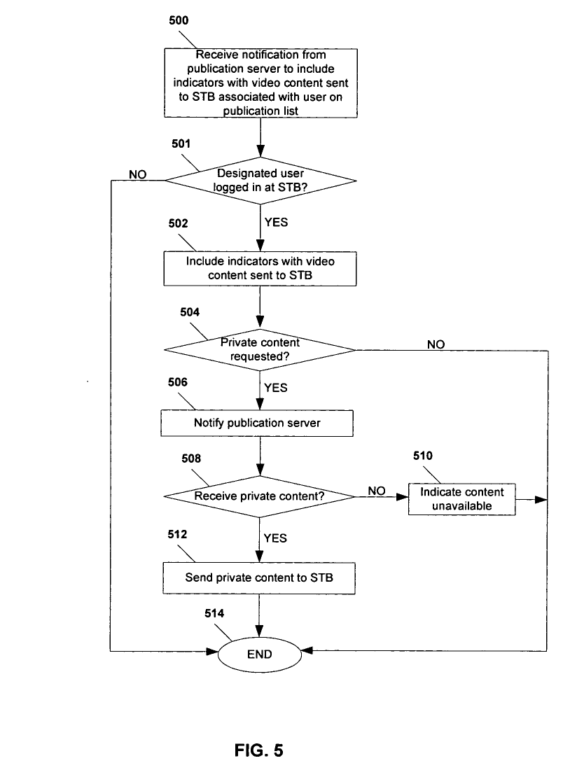

Referring to FIG. 5, a third particular illustrative embodiment of a method of sharing private content is illustrated. At block 500, a video server receives a notification, command, instructions, or any combination thereof, from a publication server to include one or more indicators with video content sent to a set-top box device of a user identified on a publication list associated with private content. The user can be one of a plurality of users identified by the publication list. In an illustrative embodiment, the video server can send the video content via an access network of an Internet Protocol Television (IPTV) system, such as the access network 166 illustrated in FIG. 1 or the IPTV access network 226 illustrated in FIG. 2.

Continuing to decision step 501, in an illustrative, non-limiting embodiment, the video server can determine whether the user identified by the publication list is logged in at the designated set-top box device. For example, the video server can query the designated set-top box device to determine who is logged in. If the video server determines that the user identified by the publication list is not logged in at the designated set-top box device, the method terminates at 514. Whereas, if the video server determines that the user identified by the publication list is logged in at the designated set-top box device, the method moves to block 502.

At block 502, the video server includes the indicators with the video content sent to the set-top box devices of the designated users. The indicators can include tags, icons, symbols, letters, numbers, or other indicators. In an illustrative embodiment, the video content can send data with the video content that causes a set-top box device to generate the indicators. In another illustrative embodiment, the video server can receive one or more indicators from the publication server, which has received designations of the indicators from a user publishing the private content. In yet another illustrative embodiment, the video server can generate the indicators.

Proceeding to decision step 504, in a particular embodiment, the video server can determine whether it has received a request to view the private content associated with one or more indicators sent with video content to a set-top box device. For example, the video server can receive data related to a selection of an indicator at the set-top box device. If the video server does not receive a request to view the private content, the method terminates at 514. Whereas, if the video server has received a request to view the private content, the method proceeds to block 506, and the video server informs the publication server that a request to view the private content has been received from the set-top box device.

Continuing to decision step 508, the video server determines whether it has received the private content. The video server can receive private content from the publication server. Alternatively, the video server can receive the private content from a share location designated by the user publishing the private content. In an illustrative embodiment, if the video server does not receive the private content, the method moves to block 510, and the video server can send an indication to the set-top box device from which the request for the private content was received, indicating that the private content is unavailable. On the other hand, if the video server receives the private content, the method advances to block 512, and the video server can send the private content to the set-top box device from which the request was issued. The method terminates at 514.

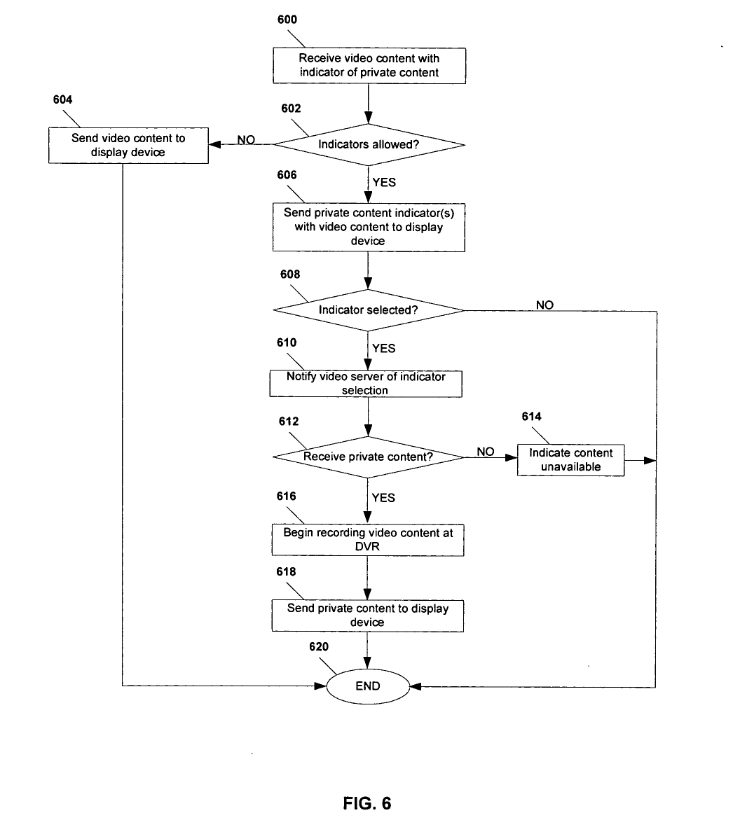

Referring to FIG. 6, a fourth particular embodiment of a method of sharing private content is illustrated. At block 600, a set-top box device receives video content from a video server, such as a video server of an Internet Protocol Television (IPTV) system. Indicators of private content can be included with the video content. Moving to block 602, in an illustrative, non-limiting embodiment, the set-top box device can determine whether indicators may be sent to a display device coupled to the set-top box device. For example, a user of the set-top box device can select an option at the set-top box device to enable private content indicators, prohibit private content indicators, or other similar options. In another example, acceptance or prohibition of indicators can be associated with a profile of a user logged in at the set-top box device.

If the set-top box device determines that indicators may not be sent to the display device, the method proceeds to block 604, and the set-top box device sends the video content without indicators to the display device. The method then terminates at 620. Conversely, if the set-top box device determines that indicators may be sent to the display device, the method proceeds to block 606, and the set-top box device sends the video content with one or more indicators to the display device. The method then proceeds to decision step 608.

At decision step 608, the set-top box device determines whether an indicator of private content has been selected. For example, an indicator can overlay video content and can be selectable via a remote control. In another embodiment, the indicator can be selected via a menu of selectable commands. Examples of graphical user interfaces to share private content are illustrated in FIGS. 7 and 8. If an indicator of private content is not selected, the method terminates at 620. On the other hand, if the set-top box device determines that an indicator of private content has been selected, the method proceeds to block 610, and the set-top box device notifies the video server, from which the video content is received, that an indicator of private content has been selected. In an illustrative embodiment, where multiple indicators corresponding to a plurality of separate portions of private content are displayed with the video content, the set-top box device can indicate to the video server which indicator has been selected.

Proceeding to decision step 612, the set-top box device determines whether it has received the private content from the video server. In a particular embodiment, if the set-top box device does not receive the private content from the video server, the method moves to block 614, and the set-top box device can send an indication that the content is unavailable to the display device. In an illustrative embodiment, the set-top box device can generate the indication that the content is unavailable in response to a notification or instruction from the video server. In another illustrative embodiment, the set-top box device can receive the indication that the content is unavailable from the video server.

Returning to decision step 612, in an illustrative embodiment, if the set-top box device receives the private content from the video server, the method moves to block 616, and the set-top box device can begin recording video content received from the video server. The method proceeds to block 618, and the set-top box device sends the private content to the display device. The method terminates at 620.

In a particular embodiment, the steps of the methods described herein can be executed in the order shown by the figures. In alternative embodiments, some steps can be executed simultaneously or in alternative sequences. For example, tags, publication lists, privacy rules, share locations, and other information related to private content can be received in any order, separately or in groups of information. In another example, a video server can include multiple tags with video content sent to a single set-top box device, each tag corresponding to private content of a different publishing user.

Referring to FIG. 7, an illustrative embodiment of a graphical user interface to share private content is illustrated. The graphical user interface can be displayed on a display device 700 coupled to a set-top box device 702. The graphical user interface can include a video content region 704, in which video content received from a video server via the set-top box device 702 is displayed. Further, the graphical user interface can include one or more private content indicators 706. In a particular embodiment, the private content indicator 706 can overlay the video content region 704. A private content indicator 706 can be selectable by a user via a remote control 708 communicating with the set-top box device 702, for example, via a programmable key 710 matching a shape, color, or any combination thereof, of the indicator 706, or via another key of the remote control device 708. In a particular embodiment, private content can be viewed at the display device 700 in response to a selection of the indicator 706.

Referring to FIG. 8, a second illustrative embodiment of a graphical user interface to share private content is illustrated. The graphical user interface can be displayed on a display device 800 coupled to a set-top box device 802. The graphical user interface can include a video content region 804, in which video content received from a video server via the set-top box device 802 is displayed. Further, the graphical user interface can include a menu region 806. In a particular embodiment, the menu region 806 can overlay the video content region 804. The menu region 806 can be displayed, for example, in response to a selection of a menu key or other key on a remote control that communicates with the set-top box device 802. In another embodiment, the menu region 806 can be displayed, in response to a selection of a private content indicator 805.

The menu region 806 can include a plurality of selectable commands 808-814. For instance, the menu region 806 can include a first selectable command 808 to view private content associated with the private content indicator 805. Further, the menu region 806 can include a second selectable command 810 to disable or prohibit the display of icons or other private content indicators. In addition, the menu region 806 can include a third selectable command 812 to record video content, for example, while private content is viewed at the display device 800. In an illustrative non-limiting embodiment, the menu region 806 can include a fourth selectable command 812 to publish private content, for instance, where a user communicates with a publication server via an access network of an Internet Protocol Television (IPTV) system to designate a publication list, share location, and other information related to private content of the user. In a particular embodiment, the menu region 806 can include other selectable commands related to sharing private content.

In conjunction with the configuration of structure described herein, the system and method disclosed provide sharing of private content. Private content can include, for example, images, videos, documents, data, informational content, or any combination thereof, related to certain video content. In another embodiment, private content can include advertising content by a local business, for example, that seeks to inform regular customers without purchasing advertising time on a network. In an illustrative embodiment, a customer, subscriber, or user of an Internet Protocol Television (IPTV) system can develop private content and publish the private content to other users of the IPTV system. In a particular embodiment, the user can submit information related to the private content to a publication server of the IPTV system. For example, the user can submit a share location from which the private content can be obtained; designations of video content with which indicators of the private content are to be sent; a publication list or other identification of parties to whom indicators of the private content are to be sent with the designated video content; privacy rules related to sharing of the private content by parties identified by a publication list; designations of tags, icons, or other indicators; or any combination thereof.

In a particular embodiment, the publication server can identify one or more video servers transmitting video content designated by the user associated with the private content. The publication server can instruct or notify the video server(s) to include indicators of the private content with the designated video content sent to set-top box devices of parties identified by the user associated with the private content. The set-top box devices can receive the indicators or data related to the indicators and cause the indicators to be displayed with the video content at display devices coupled to the set-top box devices.

A party can issue a command to view the private content by selecting an indicator or by selecting a menu command to view private content associated with an indicator. In an illustrative embodiment, the party's set-top box device can notify the video server sending the video content that a request to view the private content has been received. The video server can notify the publication server of the request, and the publication server can retrieve the private content from the share location designated by the user associated with the private content. The publication can send the private content to the video server for communication to the set-top box device from which the request was received. The private content can be displayed at the display device coupled to the set-top box device.

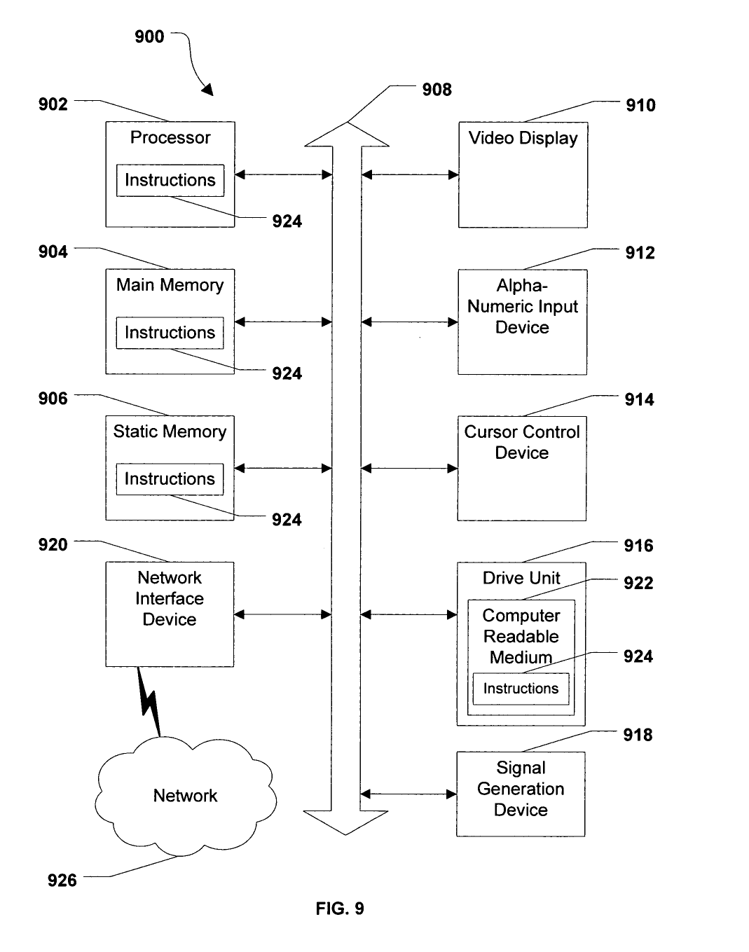

Referring to FIG. 9, an illustrative embodiment of a general computer system is shown and is designated 900. The computer system 900 can include a set of instructions that can be executed to cause the computer system 900 to perform any one or more of the methods or computer based functions disclosed herein. The computer system 900, or any portion thereof, may operate as a standalone device or may be connected, e.g., using a network, to other computer systems or peripheral devices, including a server or set-top box device, as shown in FIGS. 1-2.

In a networked deployment, the computer system may operate in the capacity of an IPTV server, such as a video server or publication server, or a set-top box device. The computer system 900 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 900 can be implemented using electronic devices that provide voice, video or data communication. Further, while a single computer system 900 is illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, e.g., a central processing unit (CPU), a graphics-processing unit (GPU), or both. Moreover, the computer system 900 can include a main memory 904 and a static memory 906 that can communicate with each other via a bus 908. As shown, the computer system 900 may further include a video display unit 910, such as a liquid crystal display (LCD), an organic light emitting diode (OLED), a flat panel display, a solid state display, or a cathode ray tube (CRT). Additionally, the computer system 900 may include an input device 912, such as a keyboard, and a cursor control device 914, such as a mouse. Further, the computer system 900 can include a wireless input device 915, e.g., a remote control device. The computer system 900 can also include a disk drive unit 916, a signal generation device 918, such as a speaker or remote control, and a network interface device 920.

In a particular embodiment, as depicted in FIG. 9, the disk drive unit 916 may include a computer-readable medium 922 in which one or more sets of instructions 924, e.g. software, can be embedded. Further, the instructions 924 may embody one or more of the methods or logic as described herein. In a particular embodiment, the instructions 924 may reside completely, or at least partially, within the main memory 904, the static memory 906, and/or within the processor 902 during execution by the computer system 900. The main memory 904 and the processor 902 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 924 or receives and executes instructions 924 responsive to a propagated signal, so that a device connected to a network 926 can communicate voice, video or data over the network 926. Further, the instructions 924 may be transmitted or received over the network 926 via the network interface device 920.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of sharing private content, the method comprising:
receiving a designation of a share location from which private content of a first user of an Internet Protocol Television (IPTV) system can be obtained;
receiving identifications of a plurality of other users of the IPTV system; and
notifying a video server to include an indicator of the private content with video content sent to a plurality of set-top box devices, wherein each of the plurality of other users is associated with one of the plurality of set-top box devices.

2. The method of claim 1, further comprising receiving a communication indicating that a request to view the private content has been issued at a requesting set-top box device, wherein the requesting set-top box device is one of the plurality of set-top box devices.

3. The method of claim 1, further comprising:
retrieving the private content from the share location; and
sending the private content to the video server, wherein the video server sends the private content to the requesting set-top box device.

4. The method of claim 2, wherein the communication is received from the video server.

5. The method of claim 2, wherein the communication is received from the requesting set-top box device.

6. The method of claim 2, further comprising determining that the requesting set-top box device is associated with one of the plurality of other users.

7. The method of claim 1, wherein the private content includes video content, an image, a document, data, or any combination thereof.

8. The method of claim 1, further comprising:
receiving a designation of video content from the first user; and
determining that the video server transmits the designated video content.

9. The method of claim 1, further comprising:
receiving at least one privacy rule from the first user;
receiving a communication indicating that a request to view the private content has been issued at a set-top box device associated with an unincluded user that is not one of the plurality of users; and
determining whether the unincluded user satisfies the at least one privacy rule.

10. The method of claim 9, further comprising:
when the unincluded user satisfies the at least one privacy rule, sending the private content to a video server communicating with the set-top box device associated with the unincluded user, wherein the video server communicates the private content to the set-top box device associated with the unincluded user.

11. The method of claim 1, wherein the identifications of the plurality of other users are included in a publication list received from the first user.

12. The method of claim 1, further comprising receiving a designation of the indicator from the first user.

13. A method of sharing private content, the method comprising:
receiving a notification at a video server to include an indicator of private content of a first user of an Internet Protocol Television (IPTV) system with video content sent to a plurality of set-top box devices, wherein each of the plurality of set-top box devices is associated with one of a plurality of other users of the IPTV system;
receiving a request to view the private content from one of the plurality of set-top box devices;
sending a communication to a publication server of the IPTV system indicating that the request has been received;
receiving the private content; and
sending the private content to the one of the plurality of set-top box devices.

14. The method of claim 13, wherein the private content is received from the publication server and wherein the publication server retrieves the private content from a share location associated with the private content.

15. The method of claim 13, further comprising:
receiving an identification of a share location associated with the private content from the publication server; and
retrieving the private content from the share location.

16. The method of claim 13, further comprising including the indicator with video content sent to the plurality of set-top box devices.

17. A method of sharing private content, the method comprising:
receiving an indicator of private content with video content from a video server at a set-top box device, wherein the private content is associated with a first user of an Internet Protocol Television (IPTV) system and the set-top box device is associated with one of a plurality of other users identified by the first user;
receiving a selection of the indicator at the set-top box device;
sending a request to view the private content to the video server; and
receiving the private content at the set-top box device.

18. The method of claim 17, wherein the indicator includes an icon, a symbol, a letter, a number, a word, or any combination thereof.

19. The method of claim 17, wherein the request includes a selection of the indicator.

20. The method of claim 17, wherein the request includes a selection of a command from a menu.

21. A set-top box device, comprising:
a processor and a memory device accessible to the processor;
a buffer to receive video content from a video server of an Internet Protocol Television (IPTV) system;
wherein the memory device includes instructions to receive an indicator of private content from the video server, wherein the private content is associated with a first user of the Internet Protocol Television (IPTV) system;
wherein the memory device includes instructions to send the indicator with the video content to a display device coupled to the set-top box device;
wherein the memory device includes instructions to receive a selection of the indicator; and
wherein the memory device includes instructions to send a request to view the private content to the video server.

22. The set-top box device of claim 21, wherein the memory device includes instructions to not send the indicator to the display device when a profile of a user logged in at the set-top box device includes a preference to block indicators, when a command to block indicators is received at the set-top box device, when a user logged in at the set-top box device is included in a publication list of the first user, or any combination thereof.

23. The set-top box device of claim 21, wherein the memory device includes instructions to receive the private content and to send the private content to the display device.

24. The set-top box device of claim 21, wherein the memory device includes instructions to send a menu of selectable commands to the display device when the indicator is selected and to receive a selection of a command to view the private content via the menu.

25. A computer program embedded in a computer-readable medium, the computer program comprising:
instructions to receive a designation of a share location from which private content of a first user of an Internet Protocol Television (IPTV) system can be obtained;
instructions to receive identifications of a plurality of other users of the IPTV system; and
instructions to notify a video server to include an indicator of the private content with video content sent to a plurality of set-top box devices, wherein each of the plurality of other users is associated with one of the plurality of set-top box devices.

26. The computer program of claim 25, further comprising:
instructions to receive a communication indicating that a request to view the private content has been issued at a requesting set-top box device, wherein the requesting set-top box device is one of the plurality of set-top box devices;
instructions to retrieve the private content from the share location; and
instructions to send the private content to the video server, wherein the video server sends the private content to the requesting set-top box device.

27. The computer program of claim 25, wherein the share location is a set-top box device coupled to a computing device that stores the private content.

28. The computer program of claim 25, wherein the designation of the share location is an IP address

29. A computer program embedded in a computer-readable medium, the computer program comprising:
instructions to receive video content and data related to an indicator of private content from a video server, wherein the private content is associated with a first user of the Internet Protocol Television (IPTV) system;
instructions to generate the indicator based on the data and to send the indicator with the video content to a display device;
instructions to receive a selection of the indicator; and
instructions to send a request to view the private content to the video server.

30. The computer program of claim 29, further comprising instructions to determine that a command to prohibit indicators has not been received, before sending the indicator to the display device.

31. The computer program of claim 29, further comprising instructions to not
